(19) United States
(12) Patent Application Publication
(10) Pub. No.: US 2014/0239821 A1
(43) Pub. Date: Aug. 28, 2014

(54) OCCUPANCY SENSOR WITH MODULAR DISCONNECT

(71) Applicant: LEVITON MANUFACTURING CO., INC., Melville, NY (US)

(72) Inventor: Thomas W. Leonard, Tualatin, OR (US)

(73) Assignee: LEVITON MANUFACTURING CO., INC., Melville, NY (US)

(21) Appl. No.: 13/779,330

(22) Filed: Feb. 27, 2013

(51) Int. Cl. H05B 37/00; H05B 41/36

(52) U.S. Cl. CPC H05B 37/00; H05B 41/36
USPC 315/158; 315/307; 315/200 R; 315/246

(57) ABSTRACT

A system has a lighting fixture has a first connector electrically coupled to a power supply, the first connector being separately electrically coupled to a load, an occupancy sensor having a second connector adapted and configured to engage the first connector, the occupancy sensor being capable of detecting a presence of a person within a monitored space, the first and second connectors forming a disconnect for the lighting fixture, and a switch located in the occupancy sensor arranged to electrically couple the power supply and the load when the first connector is coupled to the second connector and when the occupancy sensor detected a person's presence within the monitored space.

### BACKGROUND

Revisions to the National Electrical Code (NEC) in the US and the Canadian Electrical Code (CEC) in Canada now require that lighting ballasts have quick disconnects to disconnect the lighting ballast from the electrical power supply. Prior to this code, many people would work on the ballast when it was ‘live,’ or connected to the power supply. This resulted in many injuries. These lighting fixtures are often relatively high off the ground, so not only did injuries occur from the electrical shock, but also from falls.

A quick disconnect may be positioned between the ballast and the building power, and often takes the form of a plug on one side and a receptacle on the other. The side of the disconnect that is wired to the ballast is referred to as the ballast side, and the side wired to the building power is referred to as the supply side. When the ballast requires work or replacement, the electrician disconnects the ballast side from the supply side, performs the work or replacement, and then connects the ballast to the supply side of the disconnect.

The light fixtures in which the disconnects are now required often employ occupancy sensors. The occupancy sensor controls power to the load, i.e. the ballast, etc. The control of power depends upon the detection of a person's presence in a monitored space. If the sensor detects a presence, it provides power to the ballast, turning on or keeping on the lights. If the sensor does not detect a person's presence, typically for some predetermined amount of time, the sensor turns off the lights by disconnecting the light from the power.

### SUMMARY

Advantages may be obtained by combining a quick disconnect and occupancy sensor into a single device, such as being able to disconnect the ballast from the load without having to hard wire disconnects, as well as allowing easier maintenance of the lighting fixture and the occupancy sensor.

A system includes a lighting fixture having a first connector electrically coupled to a power supply, the first connector being separately electrically coupled to a load; an occupancy sensor having a second connector adapted and configured to engage the first connector, the occupancy sensor being capable of detecting a presence of a person within a monitored space, the first and second connectors forming a disconnect for the lighting fixture; and a switch located in the occupancy sensor arranged to electrically couple the power supply and the load when the first connector is coupled to the second connector and when the occupancy sensor detected a person's presence within the monitored space.

An occupancy sensor includes a housing; an occupancy detector retained in the housing, the occupancy detector operative to transmit an occupancy signal when a person's presence is detected in a monitored space; the housing having a connector with at least a first connection point and a second connection point, the first connection point to connect to a power supply and the second connection point to connect to a load; and a switch located in the housing, the switch forming a connection between the first and second connection points when the switch receives the occupancy signal from the occupancy detector.

A lighting fixture includes a ballast, the ballast electrically connected to a first connector, the first connector electrically coupled to a power supply conductor; and an occupancy sensor, the occupancy sensor including a housing, a detector for detecting a person's presence within a monitored area, and a second connector for engaging the first connector, the first and second connectors forming a disconnect between the ballast and the power supply, the second connector including first and second connection points, the first connection point being connected to the power supply, the second connection being connected to the ballast when the first connector engages the second connector so that when the first connector is coupled to the second connector the power supply is connected to the ballast, the occupancy sensor further including a switch located in the housing, the switch coupling the power supply to the ballast when the switch receives an occupancy signal from the detector.

### BRIEF DESCRIPTION OF THE DRAWINGS

FIG. 1 shows a prior art example of an occupancy sensor.

FIG. 2 shows a prior art example of an occupancy sensor wiring diagram.

FIG. 3 shows an embodiment of an occupancy system with integrated disconnect connectors.

FIG. 4 shows an embodiment of a lighting ballast having a disconnect connector.

FIG. 5 shows an embodiment of an occupancy sensor having a disconnect connector.

FIG. 6 shows an embodiment of a wiring diagram for an occupancy sensor having a disconnect.

FIG. 7 shows an alternative embodiment of a wiring diagram for an occupancy sensor having a disconnect.

### DETAILED DESCRIPTION OF THE EMBODIMENTS

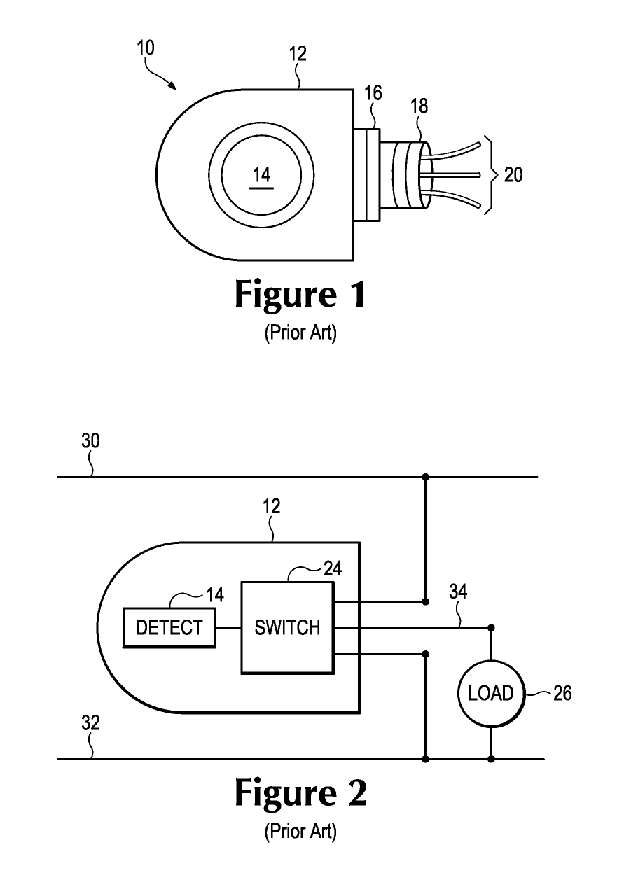

FIG. 1 shows a prior art example of an occupancy sensor 10. The sensor 10 includes an occupancy detector 14. The term ‘sensor’ as used herein refers to the entire device and its housing 12, whereas the occupancy detector 14 is a portion within the sensor 10 that detects a person's presence in a monitored space. The detector 14 may be, but not limited to, a passive infrared detector, an ultrasonic or other noise detector, a video or image detector, etc.

As this discussion focuses on lighting fixtures that use ballasts, which are typically, but not necessarily, gas discharge lighting fixtures used in larger, industrial or commercial spaces, the fixtures and therefore the sensors may be positioned relatively high up in the space. Thus, the detector 14 may be positioned in a bottom of the housing 12. The detector 14 may at least partially be retained in the housing, and some portion of the detector 14 having external access to the monitored space in order to function as a detector.

The occupancy sensor 10 includes a connector 16, wherein a threaded portion 18 extends from the connector 16. The connector 16 is configured to install directly into a lighting fixture. A locking nut (not shown) may then screw onto the threaded portion 18 to hold the sensor 10 in place. The wires 20 may be directly wired to the supply and the load, as discussed with regard to FIG. 2.

In the prior art example of an occupancy sensor wiring diagram shown in FIG. 2, the power supply conductor also referred to as the hot conductor 30, is wired directly into the housing 12 of the occupancy sensor. The neutral conductor 32 is also wired directly into the housing 12. In addition, a load conductor 34 for the load 26 is also wired directly into the housing 12. The switch 24 is connected to the neutral and load conductors 32, 34 on one side and to the load 34 on the other side. Based upon a signal from the occupancy detector 14, the switch 24 is activated and may provide power to the load 26, such as a ballast for a lighting fixture.

The detector 14 may operate in one of many ways. For example, the detector 14 may periodically send an occupancy signal upon initially detecting a person's presence in the monitored space. The signal may be expected at pre-determined time intervals, such that the absence of a signal at a pre-determined interval may indicate that the space is no longer occupied. This is merely one example of the functioning of an occupancy sensor. Other sensors may not send a signal as long as someone is detected in a monitored space, and only send a ‘non-occupancy’ signal when occupancy has not been detected for a pre-determined period of time.

Regardless of the particular mechanism used by the detector 14, the switch 24 electrically connects the power supply and the load 26 when the monitored space is occupied. When the monitored space is unoccupied, the switch 24 disconnects the power supply and the load 26, turning off the lights.

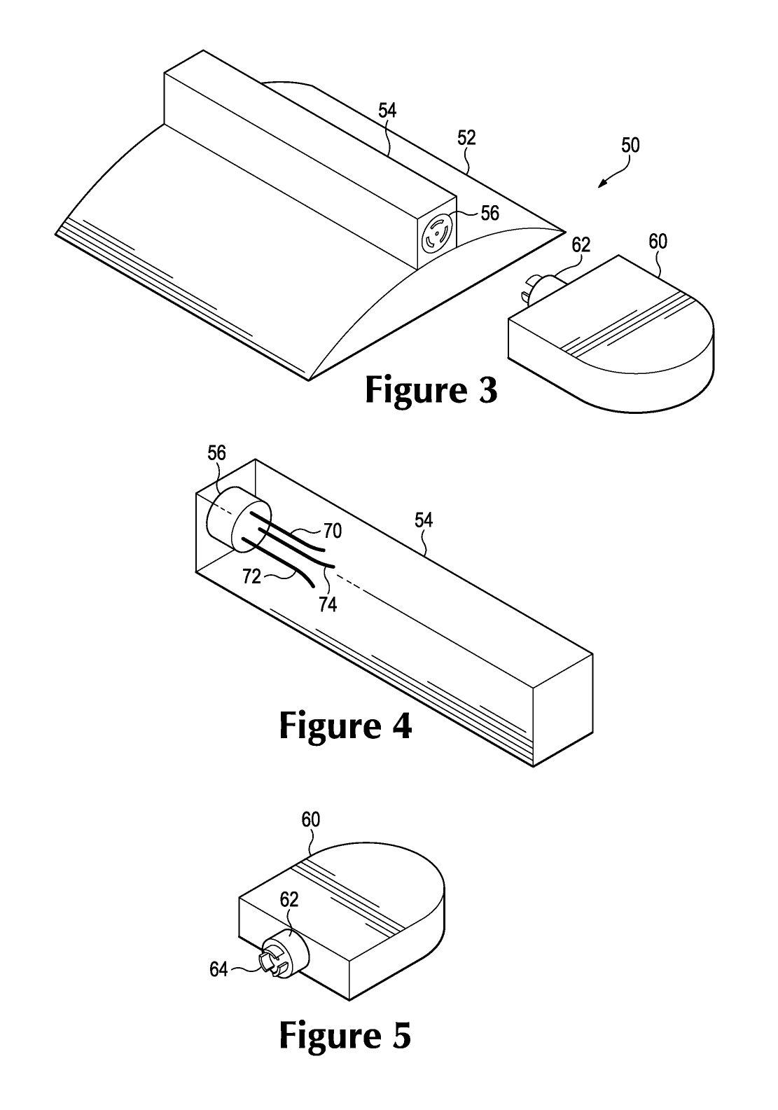

The new code requirement of having disconnects, sometimes referred to as ‘quick’ disconnects, between the ballast and the power supply has increased the complexity of the connections. However, in combining the occupancy sensor wiring with a quick disconnect connection allows for modular ballast disconnects through the occupancy sensors. FIG. 3 shows an embodiment of an occupancy sensing system having a ballast disconnect.

In FIG. 3, the lighting and sensing system 50 includes a lighting fixture 52 and an occupancy sensor 60. The lighting fixture 52 includes a ballast, generically illustrated as 54, wherein the ballast connects one or more lamps in the fixture to the power. The ballast 54 includes a first connector 56 electrically associated with it in order to provide a first portion of a ballast disconnect. For example, the ballast 54 may include the first connector 56 formed therein or the first connector 56 may be electrically coupled to the ballast 54 via a plurality of wires. Typically, disconnects have a first portion that connects to the ballast and a second portion that connects to the power supply. The first and second portions typically include male/female connectors that can easily be separated to break the connection. Each portion of this system will be discussed in turn. It should be understood that the term connector as used herein may apply to either a plug or a receptacle.

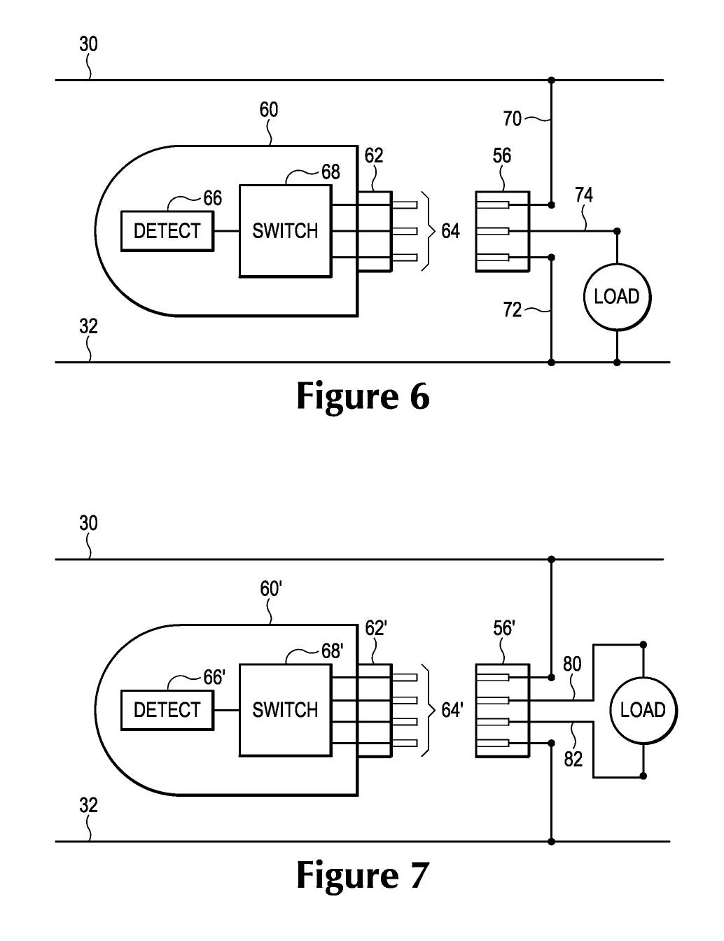

FIG. 4 shows a more expanded view of the ballast 54. The ballast 54 includes a connector 56. In this embodiment, the connector 56 is a receptacle. The connector 56 includes three conductors: a supply conductor 70, a neutral conductor 72, and a load conductor 74. The supply conductor 70 is configured to connect to the power supply; the neutral conductor 72 is configured to connect to neutral; and the load conductor 74 is configured to connect to the load (i.e. ballast, lamps, etc.). One must note that there is no connection between the supply conductor 70 and the load conductor 74, effectively disconnecting the ballast 54 from the power supply. The connection is made through the occupancy sensor connector 62, as shown in FIG. 5 and discussed in detail with regard to FIGS. 6 and 7.

In FIG. 5, the occupancy sensor 60 includes an occupancy sensor connector 62. The conductors 64 may extend from the occupancy sensor connector 62. In the embodiment shown in FIG. 5, there are three conductors 64 shown in a particular configuration, but any type of plug and receptacle combination allowable under the electrical code is considered to be within the scope of the embodiments. Any of the variations for the components discussed here, whether with regard to the prior art or any current embodiments, are considered within the scope of the embodiments here. The occupancy sensor 60 provides the connection between the ballast and the power supply, as shown in FIGS. 6 and 7.

In FIG. 6, the power supply may include a 120, 277 and 347 VAC supply having a power or hot conductor 30 and a neutral conductor 32. These conductors connect to the connector 56 that is electrically associated with the ballast. The load conductor 74 provides power to the ballast and the load in the fixture, but does not connect to the power supply within the ballast. Instead, the occupancy sensor 60 includes an occupancy sensor connector or second connector 62 that connects the supply conductor 70 and the neutral conductor 72 to the load conductor 74 through the switch 68. The first connector 56 that is electrically associated with the ballast has a supply conductor 70, a neutral conductor 72 and a load conductor 74 that connects to the load, but there is no connection until the sensor 60 and its associated occupancy sensor connector 62 is attached. The load conductor 74 is shown as a simple wire in this discussion, merely for ease of understanding, however, it should be understood that there may be more than one conductor connected to the ballast.

When the occupancy sensor 60 is ‘plugged’ into or otherwise connected to the connector 56, and a presence is detected, the switch 68 in response to the detector 66 connects the power conductor 30 to the load conductor 74. If the detector 66 does not detect a person's presence, the switch 68 does not provide power. Similarly, if a user needs to work on the lighting fixture, the occupancy sensor 60 can be disconnected from the fixture, effectively disconnecting the ballast from the power.

FIG. 7 shows an alternative embodiment of a wiring diagram for an occupancy sensor having a disconnect. The wiring diagram shown in this embodiment is substantially identical to the embodiment shown in FIG. 6, except for the following distinctions. For example, the power supply may be 240V or 480V, instead of 110-120V. In this embodiment, the supply conductors 30 and 32 are both power conductors, rather than a power conductor and a neutral conductor. There are also two load conductors 80 and 82, instead of one. Conductors 30, 32, 80, 82 connect to the connector 56′, but do not connect to each other in the absence of the occupancy sensor 60′. The connector 56′ has supply power and the line to the load/ballast, but there is no connection until the sensor 60′ and its occupancy sensor connector 62′ are attached.

An occupancy sensor connector 62′ having a plurality of conductors 64′ extends from the occupancy sensor 60′. The conductors 64′ couple the connections from the connector 56′ to the switch 68′. As described above, the switch 68′ connects the power conductors 30, 32 to the load conductors 80, 82 depending upon the input, or lack thereof, from the detector 66′. To disconnect the ballast from the supply, one merely has to disconnect the occupancy sensor from the ballast connector.

Various modifications and adjustments are considered to be within the scope of the embodiments here. For example, the occupancy sensor housing may be one of many different form factors. Further, the switch that makes the connection between the power supply and the load conductors may take one of many forms. It may be as simple as a transistor or other simple switch or as complicated as a microcontroller or processor with software that monitors the detector and makes the connection or not.

In this manner, a modular disconnect is provided to the lighting fixture, meeting the code requirement of having a quick disconnect between the power and the ballast. This also provides the functionality of an occupancy sensor to the lighting system. The occupancy sensor could be set to be ‘always on’ when plugged in, essentially causing it to just act as a ballast disconnect. This system has further advantages that the occupancy sensor can be mounted to the fixture without any additional wiring or support. The equipment manufacturers can install the connector as part of the manufacturing process and pack the sensor separately, rather than having to ship the sensor in the installed configuration that can lead to damage. The sensor can be replaced without tools or exposure to live wires or parts. The ballasts can be de-energized for replacement or repair by simply unplugging the sensor.

It will be appreciated that several of the above-disclosed and other features and functions, or alternatives thereof, may be desirably combined into many other different systems or applications. Also, various presently unforeseen or unanticipated alternatives, modifications, variations, or improvements therein may be subsequently made by those skilled in the art which are also intended to be encompassed by the following claims.

What is claimed is:

1. A system, comprising:
a lighting fixture having a first connector electrically coupled to a power supply, the first connector being separately electrically coupled to a load;
an occupancy sensor having a second connector adapted and configured to engage the first connector, the occupancy sensor being capable of detecting a presence of a person within a monitored space, the first and second connectors forming a disconnect for the lighting fixture; and
a switch located in the occupancy sensor arranged to electrically couple the power supply and the load when the first connector is coupled to the second connector and when the occupancy sensor detected a person's presence within the monitored space.

2. The system of claim 1, the lighting fixture further comprising a gas discharge lighting fixture with a ballast.

3. The system of claim 2, wherein the first connector is electrically coupled to the ballast.

4. The system of claim 3, wherein the first connector is electrically coupled to the ballast via a plurality of wires.

5. The system of claim 2, wherein the first connector is mounted on one of a housing for the ballast or a housing for the lighting fixture.

6. The system of claim 5, wherein the first connector is flush mounted.

7. The system of claim 1, wherein the occupancy sensor, comprises:
a housing;
a detector retained in the housing, the detector exposed through a surface of the housing, the detector adapted and configured to output an occupancy signal to the switch upon detecting a person's presence within the monitored space; and
the second connector extending from the housing.

8. The system of claim 7, wherein the detector is selected from the group consisting of a passive infrared detector, an ultrasonic detector, and a sound detector.

9. The system of claim 1, wherein the power supply comprises an alternating current supply selected from the group consisting of 120V, 277V, and 347V.

10. The system of claim 1, wherein the power supply is selected from the group consisting of 240V and 480V.

11. An occupancy sensor, comprising:
a housing;
an occupancy detector retained in the housing, the occupancy detector operative to transmit an occupancy signal when a person's presence is detected in a monitored space;
the housing having a connector with at least a first connection point and a second connection point, the first connection point to connect to a power supply and the second connection point to connect to a load; and
a switch located in the housing, the switch forming a connection between the first and second connection points when the switch receives the occupancy signal from the occupancy detector.

12. The occupancy sensor of claim 11, wherein the occupancy detector is selected from the group consisting of a passive infrared detector, an ultrasonic detector, and a sound detector.

13. The occupancy sensor of claim 11, wherein the first connection point is a power connection, the second connection point is a load connection, and the connector includes a third connection point that is a neutral connection.

14. The occupancy sensor of claim 11, wherein the connector comprises a first portion of a disconnect.

15. A lighting fixture, comprising:
a ballast, the ballast electrically connected to a first connector, the first connector electrically coupled to a power supply conductor; and
an occupancy sensor, the occupancy sensor including a housing, a detector for detecting a person's presence within a monitored area, and a second connector for engaging the first connector, the first and second connectors forming a disconnect between the ballast and the power supply, the second connector including first and second connection points, the first connection point being connected to the power supply, the second connection being connected to the ballast when the first connector engages the second connector so that when the first connector is coupled to the second connector the power supply is connected to the ballast, the occupancy sensor further including a switch located in the housing, the switch coupling the power supply to the ballast when the switch receives an occupancy signal from the detector.
